(19) United States
(12) Patent Application Publication
(10) Pub. No.: US 2013/0091177 A1
(43) Pub. Date: Apr. 11, 2013

(54) GENERATING ALTERNATE LOGICAL DATABASE STRUCTURE OF HIERARCHICAL DATABASE USING PHYSICAL DATABASE STRUCTURE

(71) Applicants: Kostadin A. KOSTADINOV, Jan Jose, CA (US); Francis J. RICCHIO, San Jose, CA (US); Judy Y. TSE, San Jose, CA (US); Fumitaka URUMA, Yokohama City (JP); Terrence E. WALKER, San Jose, CA (US); Toshiro YONEDA, Kanagawa (JP)

(72) Inventors: Kostadin A. KOSTADINOV, Jan Jose, CA (US); Francis J. RICCHIO, San Jose, CA (US); Judy Y. TSE, San Jose, CA (US); Fumitaka URUMA, Yokohama City (JP); Terrence E. WALKER, San Jose, CA (US); Toshiro YONEDA, Kanagawa (JP)

(73) Assignee: International Business Machines Corporation, Armonk, NY (US)

(21) Appl. No.: 13/269,826

(22) Filed: Oct. 10, 2011

(51) Int. Cl. G06F 7/00

(52) U.S. Cl. 707/803; 707/E17.044

(57) ABSTRACT

Method for generating an alternate logical database structure of a hierarchical database by a computing device, includes: determining a target level of a physical hierarchical database structure corresponding to a root level of a logical hierarchical database structure; accessing a current level of the physical hierarchical database structure equal to the target level; decrementing the current level by the computing device; accessing the decremented current level of the physical hierarchical database structure; and in response to determining that the decremented current level is a root level of the physical hierarchical database structure, repositioning the current level to the target level. In response to determining that the decremented current level is not the root level of the physical hierarchical database structure, repeating the decrementing of the current level and the accessing of the decremented current level of the physical hierarchical database structure by the computing device.

### BACKGROUND

A hierarchical database is physically structured with hierarchical levels, where there is a root level (Level 1) and level(s) dependent on the root level (Level 2, Level 3, etc.). The hierarchical database is typically accessed in the sequence of the physical database structure, beginning with the root level and traversing to the desired level via a path through any intervening dependent levels. When a hierarchical database record needs to be accessed in an alternate database structure sequence, i.e., a structure other than the physical database structure, the hierarchical sequence of the physical database structure cannot be used. A separate, logical database must be physically created with the alternate structure sequence in order to facilitate access in the desired sequence.

To illustrate, consider a hierarchical database with a physical structure that has levels 1, 2, 3, and 4, where level 1 is the root of the database record. The physical structure can be used to access levels 1, 2, 3, and 4 in sequence. However, assume that an application requires access to level 3 first, and then access to parent levels 1 and 2, and then access to dependent level 4. In this case, the hierarchical database's physical structure cannot be used since the database structure is traversed from the physical root level down to dependent levels in sequence, and access to a parent level from a dependent level is not possible. In order to access the hierarchical database record in the sequence required by the application, a separate logical database structure must be created to represent the logical database structure, where level 3 is the root level of the logical database structure, with dependent levels 1, 2, and 4. However, physically creating the logical database structure is resource intensive. Further, since the physical database record has a level indicator, which is used to maintain each level of the database record, a different processing mechanism may be required for the actual access of the logical database structure levels in order to access the levels in the desired sequence.

### SUMMARY

According to one embodiment of the present invention, a method for generating an alternate logical database structure of a hierarchical database, comprises: determining a target level of a physical hierarchical database structure corresponding to a root level of a logical hierarchical database structure by a computing device; accessing a current level of the physical hierarchical database structure equal to the target level by the computing device; decrementing the current level by the computing device; accessing the decremented current level of the physical hierarchical database structure by the computing device; and in response to determining that the decremented current level is a root level of the physical hierarchical database structure, repositioning the current level to the target level by the computing device. The repositioning to the target level provides the capability to access the levels dependent on the target level in the normal order of the physical hierarchical database.

In one aspect of the present invention, the method further comprises: in response to determining that the decremented current level is not the root level of the physical hierarchical database structure, repeating the decrementing of the current level and the accessing of the decremented current level of the physical hierarchical database structure by the computing device.

In one aspect of the present invention, the determining of the target level of the physical hierarchical database structure corresponding to the root level of the logical hierarchical database structure and the accessing of the current level of the physical hierarchical database structure equal to the target level, comprise: obtaining an alternate access key comprising a concatenated key associated with the target level by the computing device; and accessing the current level of the physical hierarchical database structure using the concatenated key by the computing device.

In one aspect of the present invention, the accessing of the decremented current level of the physical hierarchical database structure, comprises: determining a combined key length (X) for the decremented current level and parent levels of the decremented current levels by the computing device; determining a next concatenated key as the first X number of characters of the alternate access key by the computing device; and accessing the decremented current level of the physical hierarchical database structure using the next concatenated key by the computing device.

In one aspect of the present invention, the repositioning of the current level to the target level in response to determining that the decremented current level is a root level of the physical hierarchical database structure, comprises: in response to determining that the decremented current level is the root level of the physical hierarchical database structure, repositioning the current level to the target level using the alternate access key by the computing device.

In one aspect of the present invention, the accessing of the current level of the physical hierarchical database structure equal to the target level, comprises: accessing the current level of the physical hierarchical database structure equal to the target level without physically creating the logical hierarchical database structure by the computing device.

In one aspect of the present invention, the accessing of the decremented current level of the physical hierarchical database structure, comprises: accessing the decremented current level of the physical hierarchical database structure without physically creating the logical hierarchical database structure by the computing device.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system for generating an alternate logical database structure of a hierarchical database in according with the present invention.

FIG. 2 is a flowchart illustrating an embodiment of a method for generating an alternate logical database structure of a hierarchical database according to the present invention.

FIGS. 3A and 3B illustrate example hierarchical database structures accessed according to the embodiment of the method of the present invention.

FIG. 4 is a flowchart illustrating in more detail the embodiment of the method for generating an alternate logical database structure of a hierarchical database according to the present invention.

FIG. 5 illustrates a more detailed example of a hierarchical database structure accessed according to the embodiment of the method of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

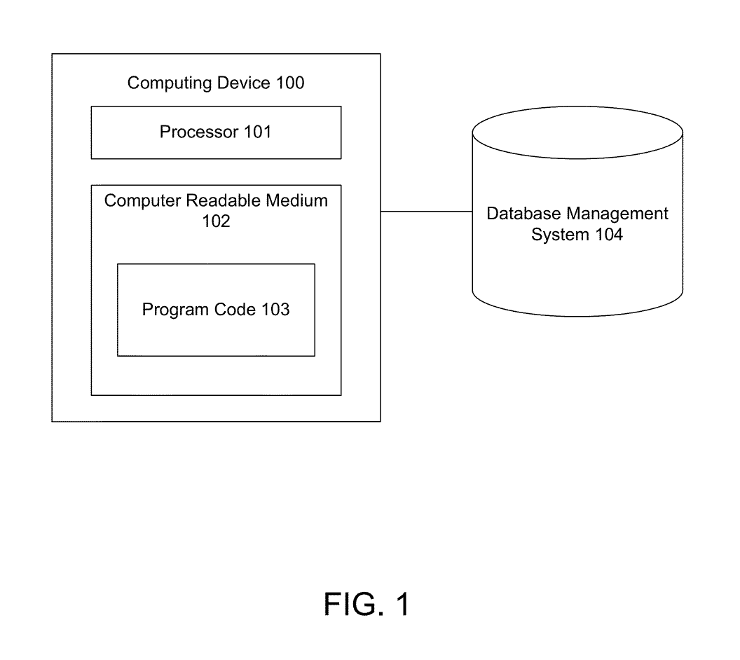

FIG. 1 illustrates an embodiment of a system for generating an alternate logical database structure of a hierarchical database in according with the present invention. The system comprises a computing device 100 operationally coupled to a processor 101 and a computer readable medium 102. The computer readable medium 102 stores computer readable program code 103, and the processor 101 executes the program code 103 to generate an alternate logical database structure of a hierarchical database of a database management system 104 according to the various embodiments of the present invention.

The present invention generates an alternate logical database structure without physically creating a logical database structure. The present invention uses the physical structure of the hierarchical database to access the various level of the alternate logical database structure. The same processing mechanisms used to access the physical database structure, can be used to access the levels of the alternate logical database structure in the proper sequence.

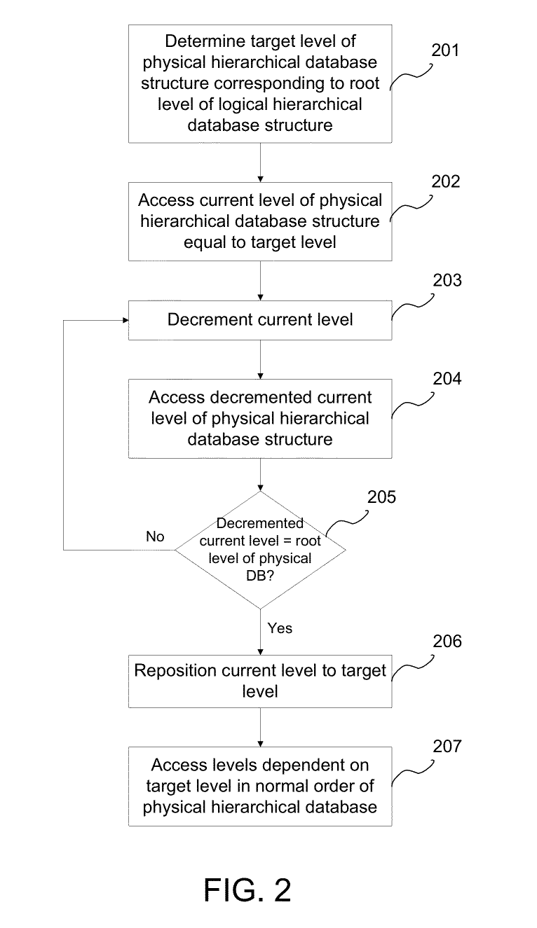

FIG. 2 is a flowchart illustrating an embodiment of a method for generating an alternate logical database structure of a hierarchical database according to the present invention. The method determines a target level of the physical hierarchical database structure corresponding to a root level of a logical hierarchical database structure (201). Definition of the target level sets the “current level” of access. The method accesses the current level of the physical hierarchical database structure equal to the target level (202). The method decrements the current level (203), and accesses the decremented current level of the physical hierarchical database structure (204). The method then determines if the decremented current level is the root level of the physical hierarchical database (205). In response to determining that the decremented current level is not the root level of the physical hierarchical database (205), steps 203 and 204 are repeated. In response to determining that the decremented current level is the root level of the physical hierarchical database, the method repositions the current level to the target level (206). The repositioning to the target level provides the capability to access the levels dependent on the target level in the normal order of the physical hierarchical database (207), using known methods. If the current level is not repositioned to the target level, the next level accessed would incorrectly be the immediate dependent level to the physical root level, or Level 2. By repositioning the current level to the target level, the level dependent on the target level would be corrected accessed next. This repositioning of the current level after reaching the physical root level allows the use of the same I/O processing for accessing both the physical and logical database structures.

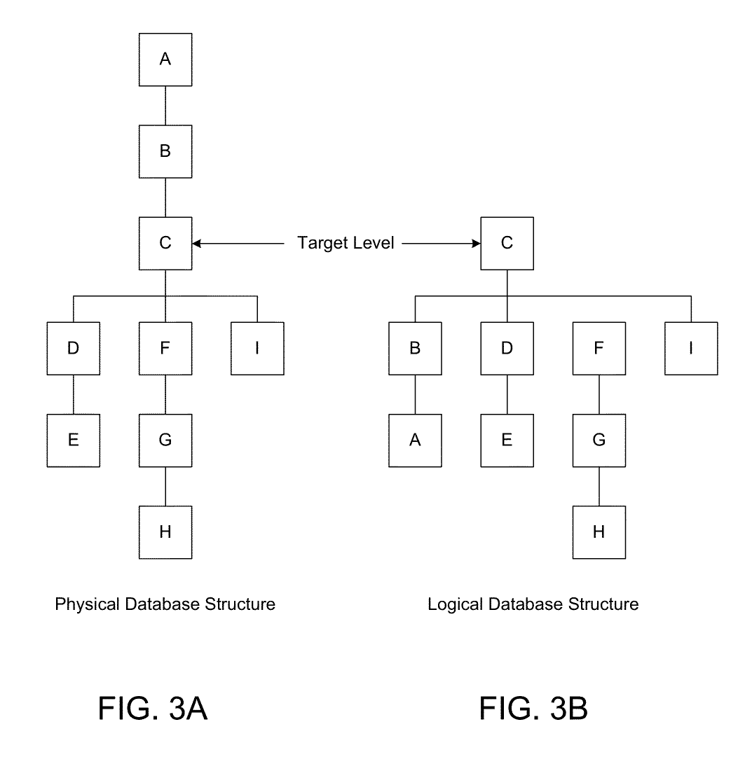

FIGS. 3A and 3B illustrate example hierarchical database structures accessed according to the embodiment of the method of the present invention. FIG. 3A illustrates a physical hierarchical database structure, where A (Level 1) is the physical root level, B (Level 2) is the immediate dependent level of A, and C (Level 3) is the immediate dependent level of B. D, E, F, G, H, and I are dependent levels (Levels 4-6) of C in the manner illustrated. The physical hierarchical database structure illustrated in FIG. 3A is stored in the database management system 104 in a manner known in the art.

Assume that C (Level 3) is application or user defined as the target level. C thus is the root level of the logical hierarchical database structure. FIG. 3B illustrates a logical hierarchical database structure, where C (Level 3) is the target level or logical root level, B (Level 2) is the immediate logical dependent level of the target level C, and A (Level 1) is the immediate logical dependent level of B. D, E, F, G, H, and I are logical dependent levels (Levels 4-6) of C, with dependencies as shown. FIG. 3B is provided for illustrative purposes only. The embodiments of the method of the present invention do not physically create the logical hierarchical database structure.

Referring to both FIGS. 2 and 3A, in accessing the physical hierarchical database structure illustrated in FIG. 3A in the sequence of the logical hierarchical database structure illustrated in FIG. 3B, the method determines the target level C of the physical hierarchical database structure corresponding to the root level of the logical hierarchical database structure (201). Level 3 is thus the “current level”. The method accesses C, the current level of the physical hierarchical database structure equal to the target level (202). The method decrements the current level from Level 3 to Level 2 (203). The method accesses B, the decremented current level of the physical hierarchical database structure (204). In response to determining that B (Level 2) is not the root level of the physical hierarchical database (205), the method again decrements the current level from Level 2 to Level 1 (203). The method then accesses A, the decremented current level of the physical hierarchical database structure (204). In response to determining that A (Level 1) is the root level of the physical hierarchical database structure (205), the method repositions the current level to Level 3, the target level (206). The repositioning to the target level provides the capability to access levels D, E, F, G, H, and I in the normal order of the physical hierarchical database (207), using known methods.

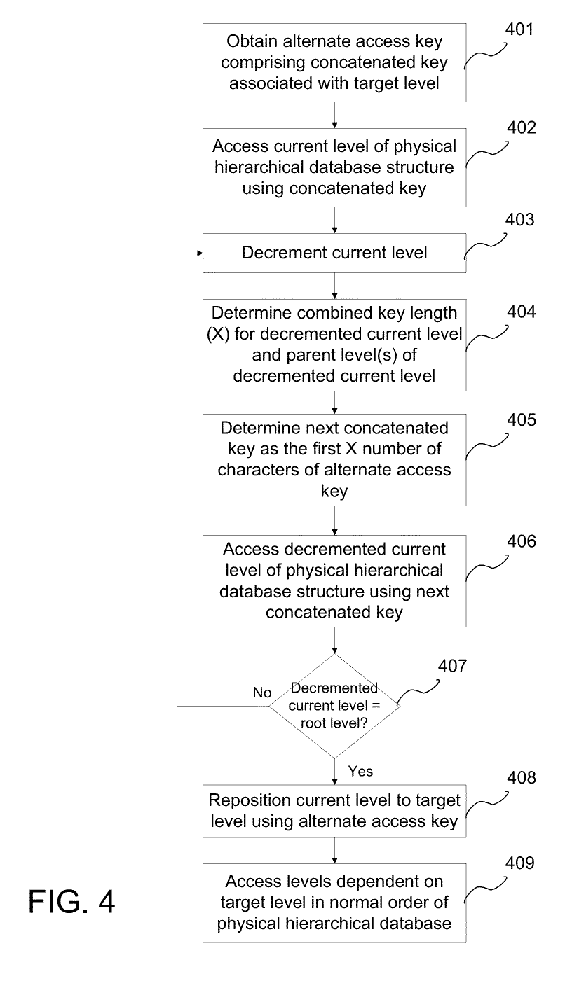

FIG. 4 is a flowchart illustrating in more detail the embodiment of the method for generating an alternate logical database structure of a hierarchical database according to the present invention. Logical blocks describing each record and its levels in the physical hierarchical database structure are stored in one or more tables. The key of the target level is also stored as an alternate access key. Any manner of storing this information may be used. In this embodiment, access to a parent level of a current level is accomplished through a manipulation of the concatenated key associated with the target level and passing the manipulated key to an access call.

The method obtains an alternative access key comprising the concatenated key associated with the target level (401). The method accesses a current level of the physical hierarchical database structure using the concatenated key (402), and decrements the current level (403). The method determines a combined key length (X) for the decremented current level and the parent level(s) of the decremented current level (404), and determines the next concatenated key as the first X number of characters of the alternate access key (405). The method accesses the decremented current level of the physical hierarchical database structure using the next concatenated key (406). The method then determines whether the decremented current level is the root level of the physical hierarchical database structure (407). In response to determining that the decremented current level is the root level of the physical hierarchical database structure, the method repositions the current level to the target level using the alternate access key (408). The repositioning to the target level provides the capability to access the levels dependent on the target level in the normal order of the physical hierarchical database (409), using known methods. In response to determining that the decremented current level is not the root level of the physical hierarchical database structure (205), steps 403 through 406 are repeated.

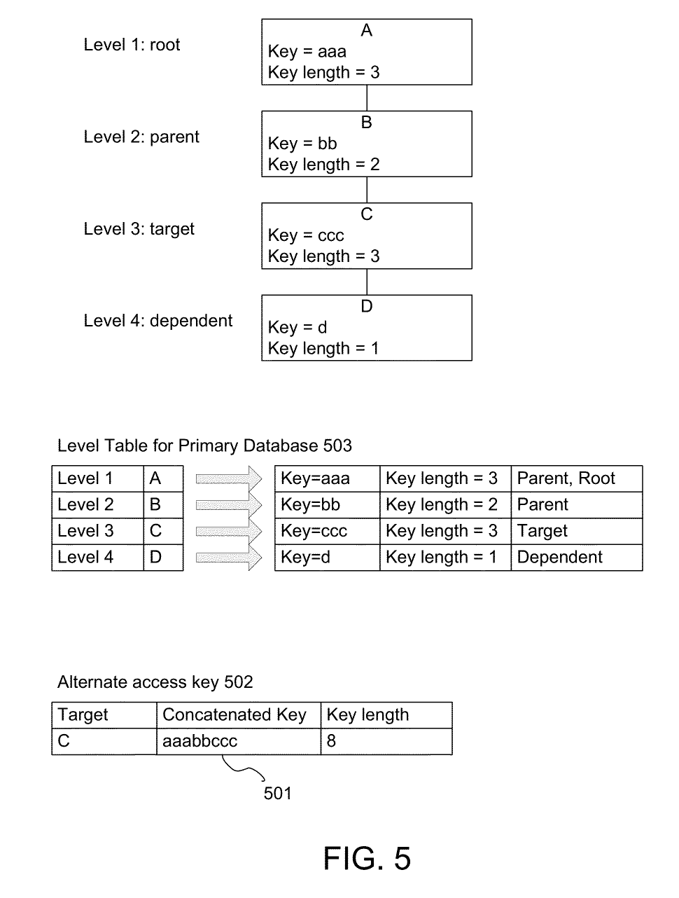

FIG. 5 illustrates a more detailed example of a hierarchical database structure accessed according to the embodiment of the method of the present invention. In this example, assume the physical hierarchical database structure includes levels A (Level 1), B (Level 2), C (Level 3), and D (Level 4). A is the root level of the physical hierarchical database structure. B is dependent on A and the parent of C. C is the target level of the logical hierarchical database structure and dependent on B. D is dependent on C. The levels of the physical hierarchical database structure are stored in a level table 503 for a primary database. Each level is associated with a key and a key length. The keys and key lengths are not actual key and length values but are values used only for illustrative purposes. Similarly, the associated keys and key lengths are shown here with the level table for illustrative purposes only. The actual keys are variable and reside in database records and are not stored in the level table. FIG. 5 further illustrates the concatenated key 501 and key length associated with the target level C stored as the alternative access key 502 in an associated database.

Referring to both FIGS. 4 and 5, the method obtains the alternate access key 502 comprising the concatenated key 501 (‘aaabbccc’) associated with the target level C (401). The concatenated key 501 comprises a concatenation of C's key and the keys of its parent levels, A and B. C at Level 3 of the physical hierarchical database structure is accessed using the concatenated key 501 (402). The method decrements the current level from 3 to 2 (403). The method then determines the combined key length (X) for level 2 and parent level 1, where X=5 (404). The method determines the next concatenated key as the first 5 characters of the alternate access key 502 (405). Here, the next concatenated key is ‘aaabb’. The method accesses B at Level 2 using the next concatenated key of ‘aaabb’ (406). In response to determining that Level 2 is not the root level (407), the method decrements the current level from 2 to 1 (403), determines the combined key length (X) for level 1, where X=3 (404), and determines the next concatenated key as the first 3 characters of the alternate access key 502 (‘aaa’) (405). The method accesses A at Level 1 using the next concatenated key of ‘aaa’ (406). In response to determining that Level 1 is the root level of the physical hierarchical database structure (407), the method repositions the current level to C, using the alternate access key 502 (408). D at Level 4 may then be accessed in the normal order of the physical hierarchical database (409), using known methods. In this embodiment, the concatenated keys used to access the various levels of the logical hierarchical database structure are passed to the same processing call that is used to access the levels of the physical hierarchical database structure. No special or custom processing call is required.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating an alternate logical database structure of a hierarchical database, comprising:
determining a target level of a physical hierarchical database structure corresponding to a root level of a logical hierarchical database structure by a computing device;
accessing a current level of the physical hierarchical database structure equal to the target level by the computing device;
decrementing the current level by the computing device;
accessing the decremented current level of the physical hierarchical database structure by the computing device; and
in response to determining that the decremented current level is a root level of the physical hierarchical database structure, repositioning the current level to the target level by the computing device.

2. The method of claim 1, further comprising:
in response to determining that the decremented current level is not the root level of the physical hierarchical database structure, repeating the decrementing of the current level and the accessing of the decremented current level of the physical hierarchical database structure by the computing device.

3. The method of claim 1, wherein the determining of the target level of the physical hierarchical database structure corresponding to the root level of the logical hierarchical database structure and the accessing of the current level of the physical hierarchical database structure equal to the target level, comprise:
obtaining an alternate access key comprising a concatenated key associated with the target level by the computing device; and
accessing the current level of the physical hierarchical database structure using the concatenated key by the computing device.

4. The method of claim 1, wherein the accessing of the decremented current level of the physical hierarchical database structure, comprises:
determining a combined key length (X) for the decremented current level and parent levels of the decremented current levels by the computing device;
determining a next concatenated key as the first X number of characters of the alternate access key by the computing device; and
accessing the decremented current level of the physical hierarchical database structure using the next concatenated key by the computing device.

5. The method of claim 4, wherein the repositioning of the current level to the target level in response to determining that the decremented current level is a root level of the physical hierarchical database structure, comprises:
in response to determining that the decremented current level is the root level of the physical hierarchical database structure, repositioning the current level to the target level using the alternate access key by the computing device.

6. The method of claim 1, wherein the accessing of the current level of the physical hierarchical database structure equal to the target level, comprises:
accessing the current level of the physical hierarchical database structure equal to the target level without physically creating the logical hierarchical database structure by the computing device.

7. The method of claim 1, wherein the accessing of the decremented current level of the physical hierarchical database structure, comprises:
accessing the decremented current level of the physical hierarchical database structure without physically creating the logical hierarchical database structure by the computing device.

8. A computer program product for generating an alternate logical database structure, the computer program product comprising:
a computer readable storage medium having computer readable program code embodied therewith, the computer readable program code configured to:
determine a target level of a physical hierarchical database structure corresponding to a root level of a logical hierarchical database structure;
access a current level of the physical hierarchical database structure equal to the target level;
decrement the current level;
access the decremented current level of the physical hierarchical database structure; and
in response to determining that the decremented current level is a root level of the physical hierarchical database structure, reposition the current level to the target level.

9. The computer program product of claim 8, wherein the computer readable program code is further configured to:
in response to determining that the decremented current level is not the root level of the physical hierarchical database structure, repeat the decrementing of the current level and the accessing of the decremented current level of the physical hierarchical database structure.

10. The computer program product of claim 8, wherein the computer readable program code configured to determine the target level of the physical hierarchical database structure corresponding to the root level of the logical hierarchical database structure and the computer readable program code configured to access the current level of the physical hierarchical database structure equal to the target level, are further configured to:
obtain an alternate access key comprising a concatenated key associated with the target level; and
access the current level of the physical hierarchical database structure using the concatenated key.

11. The computer program product of claim 8, wherein the computer readable program code configured to access the decremented current level of the physical hierarchical database structure is further configured to:
determine a combined key length (X) for the decremented current level and parent levels of the decremented current levels;
determine a next concatenated key as the first X number of characters of the alternate access key; and
access the decremented current level of the physical hierarchical database structure using the next concatenated key.

12. The computer program product of claim 11, wherein the computer readable program code configured to reposition the current level to the target level in response to determining that the decremented current level is a root level of the physical hierarchical database structure is further configured to:
in response to determining that the decremented current level is the root level of the physical hierarchical database structure, reposition the current level to the target level using the alternate access key.

13. The computer program product of claim 8, wherein the computer readable program code configured to access the current level of the physical hierarchical database structure equal to the target level is further configured to:
access the current level of the physical hierarchical database structure equal to the target level without physically creating the logical hierarchical database structure.

14. The computer program product of claim 8, wherein the computer readable program code configured to access the decremented current level of the physical hierarchical database structure is further configured to:
access the decremented current level of the physical hierarchical database structure without physically creating the logical hierarchical database structure.

15. A system comprising:
a computing device comprising a processor and a computer readable storage medium having computer readable program code embodied therewith, wherein when the computer readable program code is executed by the processor, the computing device:
determines a target level of a physical hierarchical database structure corresponding to a root level of a logical hierarchical database structure;
accesses a current level of the physical hierarchical database structure equal to the target level;
decrements the current level;
accesses the decremented current level of the physical hierarchical database structure; and
in response to determining that the decremented current level is a root level of the physical hierarchical database structure, repositions the current level to the target level.

16. The system of claim 15, wherein the computing device further:
in response to determining that the decremented current level is not the root level of the physical hierarchical database structure, repeats the decrementing of the current level and the accessing of the decremented current level of the physical hierarchical database structure.

17. The system of claim 15, wherein the determines the target level of the physical hierarchical database structure corresponding to the root level of the logical hierarchical database structure and the accesses the current level of the physical hierarchical database structure equal to the target level, comprises:
obtains an alternate access key comprising a concatenated key associated with the target level; and
accesses the current level of the physical hierarchical database structure using the concatenated key.

18. The system of claim 15, wherein the accesses the decremented current level of the physical hierarchical database structure comprises:
determines a combined key length (X) for the decremented current level and parent levels of the decremented current levels;
determines a next concatenated key as the first X number of characters of the alternate access key; and
accesses the decremented current level of the physical hierarchical database structure using the next concatenated key.

19. The system of claim 18, wherein the repositions the current level to the target level in response to determining that the decremented current level is a root level of the physical hierarchical database structure comprises:
in response to determining that the decremented current level is the root level of the physical hierarchical database structure, repositions the current level to the target level using the alternate access key.

20. The system of claim 15, wherein the accesses the current level of the physical hierarchical database structure equal to the target level, and the access the decremented current level of the physical hierarchical database structure, comprise:
accesses the current level of the physical hierarchical database structure equal to the target level without physically creating the logical hierarchical database structure; and
access the decremented current level of the physical hierarchical database structure without physically creating the logical hierarchical database structure.
